(19) United States
(12) Patent Application Publication
(10) Pub. No.: US 2002/0036494 A1
(43) Pub. Date: Mar. 28, 2002

(54) Bearing housing with speed measurement device

(76) Inventors: Sture Ostling, Katrineholm (SE); Uno Axelsson, Katrineholm (SE); Reijo Eriksson, Katrineholm (SE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 09/964,446

(22) Filed: Sep. 28, 2001

(30) Foreign Application Priority Data
Sep. 28, 2000 (SE) 0003483-5

(51) Int. Cl. G01P 3/48; G01P 3/54

(52) U.S. Cl. 324/173

(57) ABSTRACT

A bearing housing is provided with a speed measurement device incorporating a sensor arranged to detect the rotational speed of a shaft supported in a bearing in the bearing housing. The sensor is arranged to detect at least one marking rotating with the shaft and having a cable connected to an external evaluation unit. The marking is a surface irregularity or irregular surface portion of a component present in the bearing housing for another mechanical purpose and rotating with the shaft.

This application is based on and claims priority under 35 U.S.C. § 119 with respect to Swedish Application No. 0003483-5 filed on Sep. 28, 2000, the entire content of which is incorporated herein by reference.

### FIELD OF THE INVENTION

The present invention generally relates to a bearing housing. More particularly, the present invention pertains to a bearing housing provided with a speed measurement device.

### BACKGROUND OF THE INVENTION

In a variety of different circumstances, it can be of great interest to determine the rotational speed of a rotating shaft supported in bearings disposed in a bearing housing, for example to establish sudden variations in the rotational speed. For this reason, proposals have been made involving, for example, incorporating some sort of marking in the shaft itself. Through optical detection of the mark, the rotational speed of the shaft can be determined. However this method can give questionable results because material contained in the bearing housing for lubricating purposes (e.g., fat or fat like material), occasionally may cover one or more of the markings. Thus, improper readings may result.

Other solutions have also been proposed utilizing magnetic markings which are adapted to be detected by sensors positioned in end covers of the bearing housing.

These earlier proposals require that the shaft be machined in some way or otherwise provided with an additional marking. Aside from being rather expensive, these solutions are not always particularly reliable due to various reasons associated with disturbance.

A need thus exists for a relatively simple, inexpensive and reliable measurement device in a bearing housing for metering or measuring the rotational speed of a shaft supported in at least one bearing in the bearing housing.

### SUMMARY OF THE INVENTION

The present invention provides a relatively simple, inexpensive and reliable measurement device in a bearing housing for metering or measuring the rotational speed of a shaft supported in at least one bearing in the bearing housing. The invention is particularly useful at low rotational speeds of up to, for example, 900 rpm.

In accordance with one aspect of the invention, a bearing housing is used in conjunction with a speed measurement device incorporating a sensor to detect the rotational speed of a shaft supported in a bearing in the bearing housing. The sensor is arranged to detect at least one marking rotating with the shaft and has a cable connected to an external evaluation unit. The marking is in the form of an irregular surface portion of a component present in the bearing housing for another mechanical purpose, with the component rotating with the shaft.

According to another aspect of the invention, a bearing housing has a bearing and a shaft positioned therein, with the shaft being rotatably supported by the bearing, and the bearing being arrested to the shaft by way of a lock nut and a locking washer. The lock nut and the locking washer rotate together with the shaft and each possesses an outer peripheral surface. A sensor is mounted in the bearing housing and has a free end directed at the outer peripheral surface of one of the lock nut and the locking washer. The outer peripheral surface of the one of the lock nut and the locking washer is provided with a surface irregularity which the sensor can distinguish from other portions of the outer peripheral surface of the one of the lock nut and the locking washer. The sensor is connected to a cable adapted to be connected to an evaluating unit external of the bearing housing to determine the rotational speed of the shaft by sensing the surface irregularity during rotation of the shaft.

Another aspect of the invention involves the combination of a bearing housing in which is positioned a bearing and a shaft rotatably supported by the bearing, and a speed measurement device for determining a speed of rotation of the shaft. A component different from the shaft and the bearing is positioned within the bearing housing and rotates together with the shaft. The speed measurement device includes a sensor mounted in the bearing housing and having a free end directed at the outer peripheral surface of the component. The outer peripheral surface of the component is provided with an irregular surface portion which the sensor is able to distinguish from other portions of the outer peripheral surface of the component. The sensor is connected to a cable adapted to be connected to an evaluating unit external of the bearing housing to determine the rotational speed of the shaft by sensing the irregular surface portion of the component during rotation of the shaft and the component in the bearing housing.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a side view a bearing housing with a measurement device in accordance with the present invention, with a part of the bearing housing outer wall being removed for illustrative purposes.

FIG. 2 is a side view of the upper half of the bearing housing shown in FIG. 1.

FIG. 3 is a front view of the upper half of the bearing housing shown in FIG. 2, with a portion of the housing wall cut away around the position of the sensor fitted to the upper bearing housing half.

FIG. 4 is a cross-sectional view of a component provided in the interior of the bearing housing.

FIG. 5 is a planar side view of the component shown in FIG. 4.

### DETAILED DESCRIPTION OF THE INVENTION

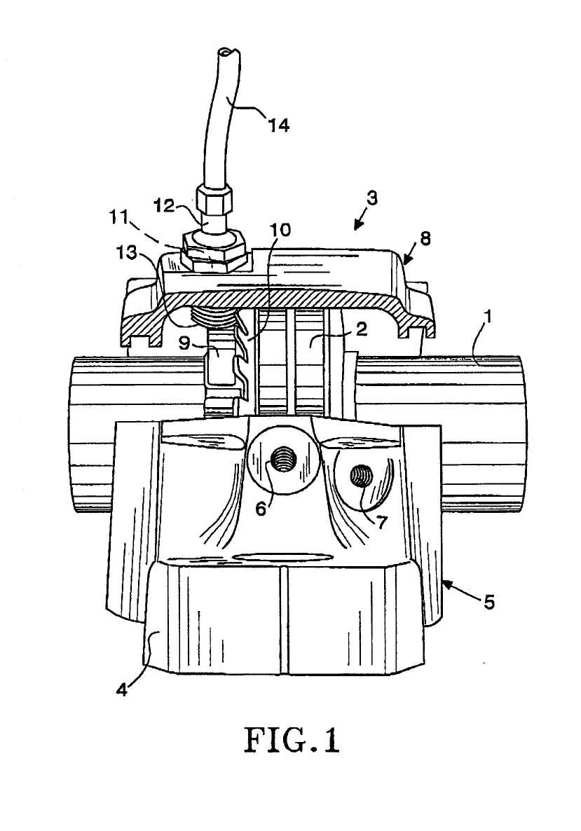

FIG. 1 illustrates a portion of a shaft rotatably supported in a bearing 2, which is fitted in a seat in a bearing housing 3. The bearing housing 3 is shown from an end face and has a base 4 made in on piece with a first, lower bearing housing half 5. In the illustrated embodiment, this lower bearing housing half 5 has a pair of threaded through holes 6, 7 intended for fitting sensors used for vibration measuring purposes. These through holes 6, 7 and their associated sensors are not specifically related to the invention here and so a further detailed description is not included.

The bearing housing 3 further includes a second, upper bearing housing half which is sometimes referred to in the art as a cap 8. The second, upper bearing housing half or cap 8 is shown in FIG. 1 with a portion cut away to illustrate a part of the interior of the bearing housing 3. The bearing 2 is attached to the shaft 1 with aid of a lock nut 9 and a locking washer 10. The cap 8 is also provided with a threaded through-hole 11 in which is inserted or positioned a sensor 12. The free end 13 of the sensor 12 is positioned at a short distance from the outer peripheral surface of the lock nut 9. The sensor 12 is connected, via a cable 14, to an external evaluation unit, for establishing and detecting the rotational speed of the shaft 1. In the described and illustrated embodiment, the sensor 12 detects the rotational speed of the lock nut 9 which rotates together with the shaft 1. The external evaluation unit 20 is schematically illustrated in FIG. 3.

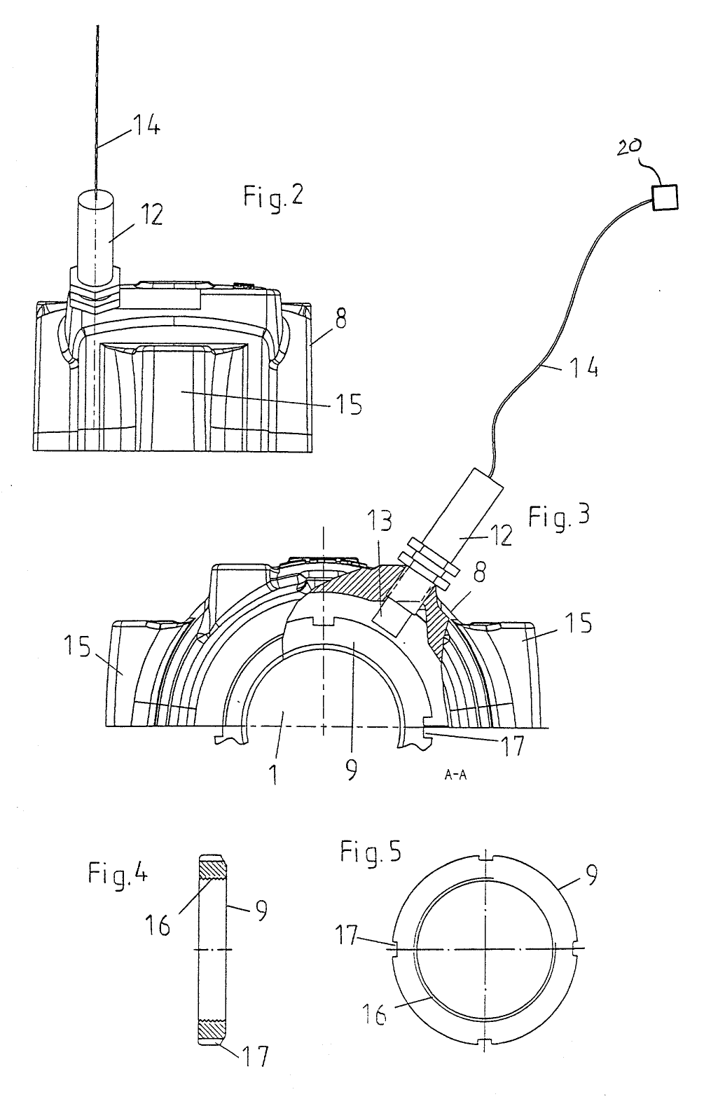

FIG. 2 illustrates, by way of an end view, the cap 8 and the position of the sensor 12 with its associated cable 14. A raised portion 15 is provided in the center of the end side of the housing. This raised portion 15 forms a seat for a bolt that connects the cap 8 to the first, lower bearing housing half or base.

FIG. 3 illustrates the bearing housing cap 8 according to FIG. 2 as seen from the front, with a portion being cut out or removed in the region of the sensor 12 for better illustrating the interior of the bearing housing. A portion of the lock nut 9 can be seen in the cut out portion. The lock nut 9 is used in a conventional manner for arresting the bearing 2 to the shaft 1 as seen in FIG. 1 and mentioned above. The lock nut 9, which is preferably a metallic lock nut, is shown in more detail in cross-section in FIG. 4 and in the end view of FIG. 5.

The lock nut 9 comprises a ring member or annular member having an internal thread 16 for connection to an external thread on the shaft 1, and by means of which the bearing can be clamped against a shoulder on the shaft 1 or the like. Externally, the ring-shaped member or lock nut 9 is provided with an irregular surface portion or surface irregularities. In the illustrated embodiment, a plurality of key grip recesses 17 constitutes the irregular surface portion or surface irregularities. The sensor 12 is able to distinguish the surface irregularities or irregular surface portion from the other portions of the outer peripheral surface of the lock nut 9.

As shown in FIG. 5, the lock nut 9 is provided with four equidistantly positioned recesses 17. These recesses 17 permit a hook spanner to be applied or utilized to tighten the lock nut 9 on a thread in the shaft or on a sleeve.

As seen in FIG. 3, the free end 13 of the sensor 12 is positioned in close proximity to the outer peripheral surface of the lock nut 9, and with its longitudinal direction positioned perpendicularly to the peripheral surface of the lock nut 9. The spacing between the end surface of the sensor 12 and the outer peripheral surface of the lock nut 9 is partly dependent on the type of sensor used. Distances up to about 2 mm are useful, although best results are obtained if the distance is about 1 mm.

When tightened, the lock nut 9 is fixedly attached to the shaft 1 so that the lock nut will rotate at the same speed as the shaft 1. To detect this rotational speed, an inductive sensor is used, for instance a sensor from Gerhard Balluff GmbH & Co, Neuhausen, Germany, available on the market under the name Balluff BES 516-325-E5-Y-S49.

With this sensor 12 positioned with its free end 13 at a distance of preferably about 1 mm from the outer peripheral surface of the lock nut 9, the sensor 12 will detect the passage of each recess 17 in the lock nut 9 as these recesses 17 move past the sensor 12 during rotation of the shaft 1 and the lock nut 9. Each passage of a recess 17 produces a pulse which, via the cable 14, is transferred to the external evaluation unit. In this manner, and with the illustrated number of recesses, each 360° revolution results in four pulses being transferred to the evaluation unit. The evaluation unit can then establish in a simple manner the current rotational speed of the shaft 1, even at comparatively low speeds, for example between 50 rpm and 900 rpm.

By utilizing the recesses present in a component like the lock nut that rotates with the shaft, with the lock nut also primarily being intended to arrest the inner ring of the bearing to the shaft, it is possible in a very simple and convenient manner to pick up signals representative of the shaft rotational speed using a standard sensor. This construction eliminates the need to provide the bearing or the shaft with special markings such as used in other known devices.

In addition, using an inductive sensor of this type, positioned at a very short distance from the surface to be scanned, the risk of disturbance in the metering or measuring result, caused by for example lubrication fat and the like, is greatly reduced and substantially eliminated, particularly when measuring against the metallic lock nut 9 and the evenly spaced recesses 17 formed in the outer surface of the lock nut 9.

Of course, it is not necessary to use lock nuts of the type illustrated, having four key grip recesses. It is also possible to use lock nuts having a different number of spaced apart recesses. For example, the lock nut can be provided with eight evenly spaced apart recesses, whereby the evaluation unit is programmed to count eight pulses for 360 degrees of rotation.

By utilizing a component (e.g., the lock nut which arrests the bearing) which is already present in the bearing housing, the only additional requirement for implementing the present invention involves providing a threaded hole for the sensor 12.

In the embodiment of the invention shown in the drawing figures and described above, the component present in the bearing housing is thus a lock nut intended primarily for another mechanical purpose, namely to arrest the bearing to the shaft, with the irregular surface portion functioning as the markings being the key grip recesses present in the outer peripheral surface of the lock nut for allowing tightening of the lock nut. The component (e.g., the lock nut), which primarily functions for other mechanical purposes, is different from the shaft and the bearing, yet rotates together with the shaft, with the sensor being adapted to distinguish the surface irregularities or irregular surface portion of the component from other portions of the component to allow the rotational speed of the shaft to be determined.

However the invention is not limited to a component such as the lock nut. The component could instead be, for example, a locking washer such as the locking washer 10 illustrated in FIG. 1. In addition, the irregular surface portion on the component is not necessarily limited to recesses, but can instead be other surface irregularities, such as elevated portions or the like.

The principles, preferred embodiment and mode of operation of the present invention have been described in the foregoing specification. However, the invention which is intended to be protected is not to be construed as limited to the particular embodiment and variations disclosed. Further, the embodiment and variations described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A bearing housing in which is positioned a bearing and a shaft rotatably supported by the bearing, the bearing being arrested to the shaft by way of a lock nut and a locking washer, with the lock nut and the locking washer rotating together with the shaft, the lock nut and the locking washer possessing an outer peripheral surface, a sensor mounted in the bearing housing and having a free end directed at the outer peripheral surface of one of the lock nut and the locking washer, the outer peripheral surface of said one of the lock nut and the locking washer being provided with a surface irregularity which the sensor can distinguish from other portions of the outer peripheral surface of said one of the lock nut and the locking washer, the sensor being connected to a cable adapted to be connected to an evaluating unit external of the bearing housing to determine the rotational speed of the shaft by sensing the surface irregularity during rotation of the shaft.

2. The bearing housing as recited in claim 1, wherein the sensor is an inductive sensor and the surface irregularity is provided on the outer peripheral surface of the lock nut which is made of a metallic material.

3. The bearing housing as recited in claim 1, wherein the surface irregularity includes a plurality of evenly distributed recesses.

4. The bearing housing as recited in claim 1, wherein the sensor includes a free end positioned about 2 mm or less from the outer peripheral surface of said one of the lock nut and the locking washer.

5. The bearing housing as recited in claim 4, wherein the distance between the free end of the sensor and the outer peripheral surface of said one of the lock nut and the locking washer is about 1 mm.

6. A combination of a bearing housing in which is positioned a bearing and a shaft rotatably supported by the bearing, and a speed measurement device for determining a speed of rotation of the shaft, a component positioned within the bearing housing and having an outer peripheral surface, the component being different from the shaft and the bearing, and the component rotating together with the shaft, the speed measurement device including a sensor mounted in the bearing housing and having a free end directed at the outer peripheral surface of the component, the outer peripheral surface of the component being provided with an irregular surface portion which the sensor is able to distinguish from other portions of the outer peripheral surface of the component, the sensor being connected to a cable adapted to be connected to an evaluating unit external of the bearing housing to determine the rotational speed of the shaft by sensing the irregular surface portion of the component during rotation of the shaft and the component in the bearing housing.

7. The combination recited in claim 6, wherein the sensor is an inductive sensor and the component is a metallic component.

8. The combination recited in claim 6, wherein the component is a lock nut that arrests the bearing with respect to the shaft.

9. The combination recited in claim 8, wherein the irregular surface portion of the component is a plurality of recesses evenly distributed on the outer peripheral surface of the lock nut.

10. The combination recited in claim 6, wherein the irregular surface portion of the component is a plurality of recesses evenly distributed on the outer peripheral surface of the component.

11. The combination recited in claim 6, wherein the sensor includes a free end positioned about 2 mm or less from the outer peripheral surface of the component.

12. The combination recited in claim 11, wherein the distance between the free end of the sensor and the outer peripheral surface of the component is about 1 mm.

13. A bearing housing provided with a speed measurement device incorporating a sensor and arranged to detect a rotational speed of a shaft supported in a bearing in the bearing housing, the sensor being arranged to detect at least one marking rotating with the shaft and having a cable connected to an external evaluation unit, the marking being an irregular surface portion of a component present in the bearing housing and primarily intended for another mechanical purpose and rotating together with the shaft.

14. The bearing housing as recited in claim 13, wherein the sensor is an inductive sensor and the component provided with the at least one marking being a metallic material.

15. The bearing housing as recited in claim 14, wherein the component provided with the at least one marking is a lock nut that arrests the bearing to the shaft, and the at least one marking being a plurality of key grip recesses evenly distributed around an outer periphery of the lock nut.

16. The bearing housing as recited in claim 15, wherein the sensor includes a free end positioned about 2 mm or less from the outer peripheral surface of the lock nut, with a longitudinal direction of the sensor being perpendicular to the outer peripheral surface of the lock nut.

17. The bearing housing as recited in claim 16, wherein the distance between the free end of the sensor and the outer peripheral surface of the lock nut is about 1 mm.

18. The bearing housing as recited in claim 13, wherein the component provided with the at least one marking is a lock nut that arrests the bearing to the shaft, and the at least one marking being a plurality of key grip recesses evenly distributed around an outer periphery of the lock nut.

19. The bearing housing as recited in claim 13, wherein the sensor includes a free end positioned about 2 mm or less from an outer peripheral surface of the component, with a longitudinal direction of the sensor being perpendicular to the outer peripheral surface of the component.

20. The bearing housing as recited in claim 19, wherein the distance between the free end of the sensor and the outer peripheral surface of the component is about 1 mm.
